(19) United States
(12) Patent Application Publication
(10) Pub. No.: US 2024/0253397 A1
(43) Pub. Date: Aug. 1, 2024

(54) NON-PNEUMATIC TIRE HAVING BALANCED SPOKE STIFFNESS

(71) Applicant: Bridgestone Americas Tire Operation, LLC, Nashville, TN (US)

(72) Inventors: Benjamin E. Rimai, Copley, OH (US); Bradley S. Plotner, Canton, OH (US); Prashant Kumar, Stow, OH (US)

(21) Appl. No.: 18/564,325

(22) PCT Filed: May 20, 2022
(86) PCT No.: PCT/US2022/072454

§ 371 Date: Nov. 27, 2023

Related U.S. Application Data
(60) Provisional application No. 63/212,202, filed on Jun. 18, 2021.

(51) Int. Cl. B60C 7/14

(52) U.S. Cl. CPC B60C 7/146

(57) ABSTRACT

A non-pneumatic tire and method of forming a non-pneumatic tire. The non-pneumatic tire includes a lower ring having a first diameter and an upper ring having a second diameter greater than the first diameter. The upper ring is substantially coaxial with the lower ring. A plurality of spokes extend between and interconnect the lower ring and the upper ring. The plurality of spokes have a tension stiffness of greater than or equal to 11 and less than or equal to 150 N/mm°, and a compression stiffness of greater than or equal to 11 and less than or equal to 100 N/mm°.

### FIELD OF INVENTION

The present disclosure relates to a non-pneumatic tire. More particularly, the present disclosure relates to a non-pneumatic tire having balanced tensile and compressive spoke stiffness to distribute a load on the tire.

### BACKGROUND

Various tire constructions have been developed that enable a tire to run in an uninflated or underinflated condition. Non-pneumatic tires do not require inflation, while “run flat” tires may continue to operate after being punctured and becoming partially or completely depressurized, for extended periods of time and at relatively high speeds. Non-pneumatic tires may include support structure, such as spokes or webbing that connects a lower ring to an upper ring. Among other design parameters, varying the tension stiffness and compression stiffness of each spoke affects non-pneumatic tire performance.

Tires with spokes having a low tension stiffness and a high compression stiffness are known as “bottom loading” tires. These tires carry a majority of a load in compression. While providing good load carrying characteristics, bottom loading tires may be deficient in regard to impact absorption performance because the spokes, due to their high compression stiffness, have a limited ability to “give” during the occurrence of an impact event. This may result in a tire with poor ride quality characteristics.

Tires with spokes having a high tension stiffness and a low compression stiffness are known as “top loading” tires. These tires carry a majority of a load in tension. While providing improved impact absorption performance over bottom loading tires, the specific tension and compression values of the spokes in the overall arrangement of top loading tires may generate undesirably high stresses or strains in tire components. Furthermore, at any given moment during rotation of the top loading tire, spokes located in the top half of the tire have a net upward pull, while spokes located in the bottom half of the tire may have a net downward pull. Consequently, the tire must be designed not only to carry a rated load, but must also be designed to overcome the downward pull of the spokes located in the bottom half of the tire. This exacerbates the aforementioned top loading tire design issue regarding the generation of undesirably high stresses or strains in tire components.

Thus, it is desired to provide a non-pneumatic tire that provides acceptable impact absorption performance while also having acceptable stress and strains in tire components.

### SUMMARY OF THE INVENTION

In one embodiment, a non-pneumatic tire includes a lower ring having a first diameter and an upper ring having a second diameter greater than the first diameter. The upper ring is substantially coaxial with the lower ring. A plurality of spokes extend between and interconnect the lower ring and the upper ring. The plurality of spokes have a tension stiffness of greater than or equal to 11 and less than or equal to

$$150 \frac{N}{mm} / ° ,$$

and a compression stiffness of greater than or equal to 11 and less than or equal to

$$100 \frac{N}{mm} / ° .$$

In another embodiment, a non-pneumatic tire includes a lower ring having a first diameter and an upper ring having a second diameter greater than the first diameter. The upper ring is substantially coaxial with the lower ring. A plurality of spokes extend between and interconnect the lower ring and the upper ring. The plurality of spokes have a tension stiffness to compression stiffness ratio in the range of 0.3:1 to 8:1.

In yet another embodiment, a method of manufacturing a non-pneumatic tire includes modeling a model tire having a model width and a model design load capacity. The method further includes selecting a reference tension stiffness value and a reference compression stiffness value based on the step of modeling, the reference tension stiffness value being greater than or equal to 11 and less than or equal to

$$150 \frac{N}{mm} / ° ,$$

the reference compression stiffness being greater than or equal to 11 and less than or equal to

$$100 \frac{N}{mm} / ° .$$

A first ideal tension stiffness and a first ideal compression stiffness are calculated for a tire design having a first design width and a first design capacity by adjusting the reference tension stiffness value and the reference compression stiffness value selected during the step of selecting. The method further includes producing a first non-pneumatic tire having the first design width and the first design capacity, and further having the first ideal tension stiffness and the first ideal compression stiffness calculated during the step of calculating.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of one embodiment of a non-pneumatic tire,

FIG. 2 is an enlarged partial front view of the non-pneumatic tire of FIG. 1,

FIG. 3 is a cross-sectional view of the non-pneumatic tire of FIG. 2 along 3-3,

FIG. 4 is a partial front view of an alternative embodiment of a non-pneumatic tire of an alternative embodiment,

FIG. 5a is a schematic drawing showing a front view of a testing arrangement for determining tension stiffness of a spoke,

FIG. 5b is schematic drawing showing a front view of a testing arrangement for determining compression stiffness of a spoke, and

FIG. 5c is a graph showing the relationship between spoke deflection and spoke force.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the side of the tire. Thus, when relative directional terms such as “inner” and “outer” are used in connection with an element, the “inner” element is spaced closer to the equatorial plane of the tire than the “outer” element.

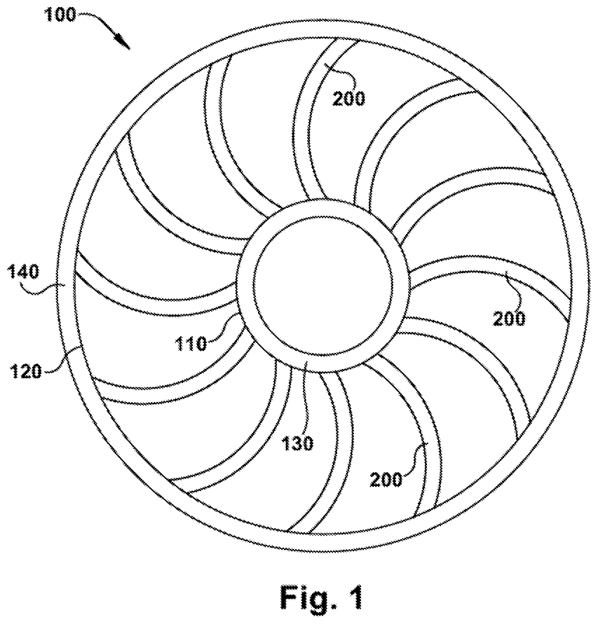

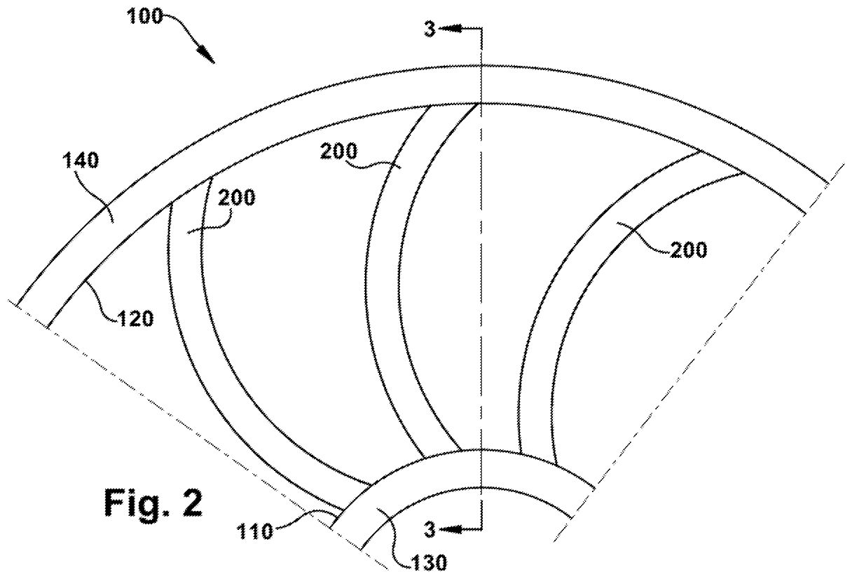

FIGS. 1 and 2 are front views of one embodiment of a non-pneumatic tire 100. The non-pneumatic tire 100 includes a lower ring 110 having a first diameter and an upper ring 120 having a second diameter greater than the first diameter. Each of the lower ring 110 and the upper ring 120 extend in an axial direction to define a tire width. The upper ring 120 is substantially coaxial with the lower ring 110. The lower ring 110 is attached to a hub 130. The hub 130 may be used to attach the non-pneumatic tire 100 to a vehicle, for example. In alternative embodiments, the hub may be omitted.

A circumferential tread 140 is disposed about the upper ring 120. The tread 140 may include tread elements such as grooves, ribs, blocks, lugs, sipes, studs, and other elements. A shear band, shear element, or reinforcement structure (not shown) may be disposed between the upper ring 120 and the tread 140. In alternative embodiments, the tread may be omitted and tread elements may be formed directly on the upper ring.

A plurality of spokes 200 extend between and interconnect the lower ring 110 and the upper ring 120. In the illustrated embodiment, the design of each one of the plurality of spokes 200 is substantially identical. Accordingly, further description of the plurality of spokes 200 will be made with reference to a single spoke. However, it should be understood that in alternative embodiments, the geometries of different spokes may vary. In other alternative embodiments, webbing may be used to interconnect the lower ring and the upper ring.

Each one of the spokes 200 extends between a first end 205 and a second end 210 along a generally radial direction of the non-pneumatic tire 100. The first end 205 is attached to the lower ring 110. The second end 210 is attached to the upper ring 120. The spoke 200 also extends between a first edge 215 and a second edge 220 along a generally axial direction of the non-pneumatic tire 100 to define a spoke width. In the illustrated embodiment, the width of the spoke 200 is slightly less than the width of the lower ring 110 and the upper ring 120. In alternative embodiments, the spoke may have a width that is equal to the lower ring or the upper ring, or the spoke may have a width that is greater than the lower ring or the upper ring.

Each spoke 200 has a first stiffness in tension, kₜ, which may be referred to as a tension stiffness. Each spoke 200 also has a second stiffness in compression, k_{c}, which may be referred to as a compression stiffness. The tension stiffness kₜ and compression stiffness k_{c} of each spoke 200 affects the performance characteristics of the non-pneumatic tire 100.

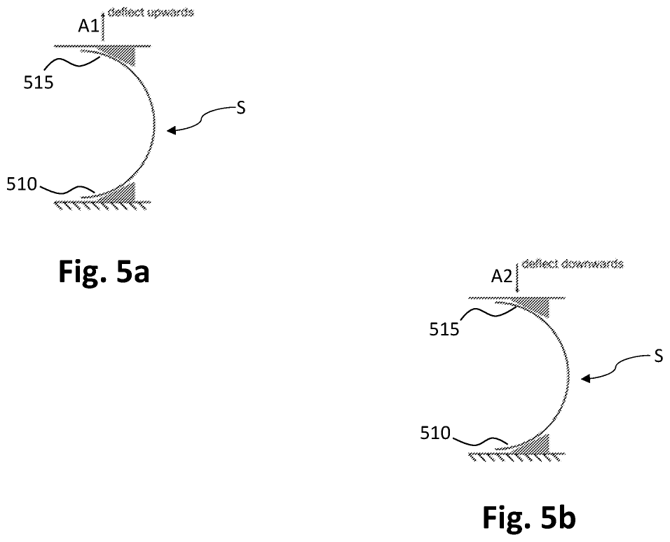

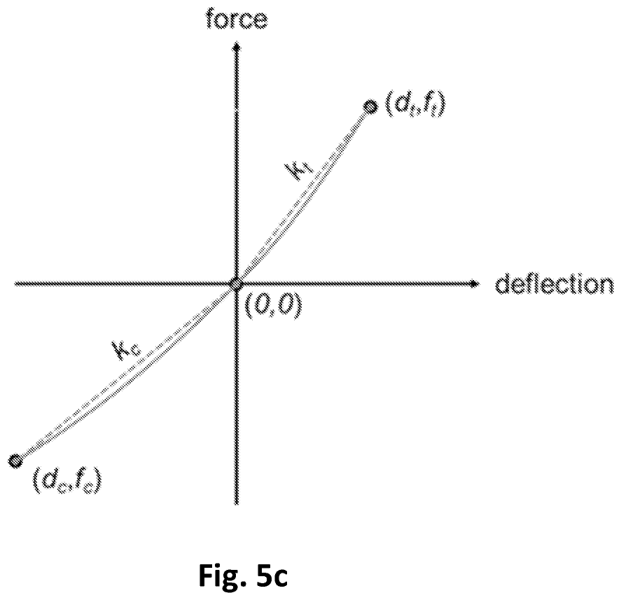

FIG. 5a is a schematic drawing showing a front view of a testing arrangement for determining tension stiffness kₜ of a spoke. A spoke sample S has a first end 510 that is held stationary and a second end 515 that is free to move relative to the first end 510. A load is applied to the second end 515 of the spoke sample S in a first direction, indicated by arrow A1. This load causes the second end 515 of the spoke S to deflect relative to the first end 510 by a tension distance dₜ (not shown in this view). The load likewise creates a tension force fₜ on the spoke sample S generates as the second end 515 moves the tension distance dₜ.

FIG. 5b is a schematic drawing showing a front view of a testing arrangement for determining compression stiffness k_{c} of the spoke sample S. In this arrangement, the load applied to the second end 515 of the spoke sample S is in a second direction, indicated by arrow A2, which is opposite the first direction shown in FIG. 5a. The load causes the second end 515 of the spoke sample S to be deflected relative to the first end 510 by a compression distance d_{c} (not shown in this view). The load also creates a compression force f_{c} on the spoke sample S as the second end 515 moves the compression distance dₜ.

The graph shown in FIG. 5c shows the relationship between spoke deflection and spoke force, with deflection being plotted along the x-axis and force being plotted along the y-axis. The right side of the graph is a plot of the tension force fₜ and the tension distance dₜ, while the left side of the graph is a plot of the compression force f_{c} and the compression distance d_{c}. Tension stiffness kₜ is determined by measuring the slope of a line connecting the point (0, 0) to the point (dₜ, fₜ). Compression stiffness k_{c} is determined by measuring the slope of a line connecting the point (0, 0) to the point (d_{c}, f_{c}).

Known non-pneumatic tires may generally be categorized as “bottom loading” or “top loading.” Bottom loading tires carry load predominantly by compression of the tire between the underlying surface on which the tire rests and the point where the load is applied to the tire, with a small fraction of the spokes located near the underlying surface carrying a majority of the load at any given moment during rotation of the tire. As such, compression stiffness of the spokes in bottom loading tires is a primary design factor, while tension stiffness of the spokes is less significant. Bottom loading tires can provide good load carrying characteristics, but may provide poor impact absorption performance.

In comparison, top loading tires carry load predominantly through the use of a hoop-like structure. Unlike a bottom loading tire where a small fraction of the spokes carry a majority of the load, the hoop-like structure of top loading tires distributes a load more evenly to all spokes in the tire. As such, both compression stiffness and tension stiffness of the spokes of top loading tires are significant design factors. In certain top loading tire arrangements, the tension stiffness of the spokes can be orders-of-magnitude higher than the compression stiffness of the spokes, which can create an imbalance of forces in the tire. Thus, while top loading tires can provide good impact absorption performance, top loading tires may suffer from undesirably high stresses or strains in tire components because of this imbalance of forces.

The present disclosure identifies equations and values that can be used to design a non-pneumatic tire that overcomes the aforementioned issues to provide a non-pneumatic tire having acceptable impact absorption performance while also having acceptable stresses and strains in tire components. Specifically, the present disclosure identifies equations and values that can be used to calculate ideal tension stiffness k_{t,degree} and ideal compression stiffness k_{c,degree} values for a tire of a desired width and a desired load capacity, with the ideal tension stiffness k_{t,degree} and ideal compression stiffness k_{c,degree} values each being expressed in spoke stiffness per degree and having units of

$$\frac{N}{mm} / ° .$$

Ideal tension stiffness k_{t,degree} and ideal compression stiffness k_{c,degree} values are most appropriately expressed in terms of spoke stiffness per degree

$$( \frac{N}{mm} / ° )$$

because the performance characteristics of the non-pneumatic tire 200 are affected by the total number of spokes 20. Generally speaking, reducing the total number of spokes requires an increase in compression and tension stiffness of each spoke, while increasing the total number of spokes requires a decrease in compression and tension stiffness of each spoke. For example, a tire is initially designed with 60 spokes and provides baseline performance characteristics. Starting from this initial design, if the total number of spokes is reduced, the tension and compression stiffness of each spoke must be increased to compensate for the spoke reduction in order to maintain the baseline performance characteristics. If the total number of spokes is increased from the initial design, the tension and compression stiffness of each spoke must be decreased to compensate for the spoke addition in order to maintain the baseline performance characteristics.

With the foregoing in mind, the following equations and values can be used to calculate ideal tension stiffness k_{t,degree} and ideal compression stiffness k_{c,degree} values expressed in terms of spoke stiffness per degree:

$$11 \leq {k}_{t , ref} \leq 150 ( \frac{N}{mm} ) / °$$

$$11 \leq {k}_{c , ref} \leq 100 ( \frac{N}{mm} ) / °$$

$${w}_{ref} = 300 mm$$

$${f}_{ref} = 22 , 200 N$$

$${k}_{t , degree} = {k}_{t , ref} ( \frac{{w}_{ref}}{w} ) ( \frac{f}{{f}_{ref}} )$$

$${k}_{c , degree} = {k}_{c , ref} ( \frac{{w}_{ref}}{w} ) ( \frac{f}{{f}_{ref}} )$$

The first step in calculating ideal tension stiffness k_{t,degree} and ideal compression stiffness k_{c,degree} values is modeling a model tire to optimize a reference tension stiffness k_{t,ref} and a reference compression stiffness k_{c,ref} values. The modeling may be performed using, for example, finite element analysis. This modeling is performed using a model tire with a specific model width w_{ref} and a specific model load capacity f_{ref}. In one example embodiment, the model tire has a width w_{ref} of 300 mm and a load capacity f_{ref} of 22,200 N.

In modeling the tire, the designer takes into consideration the intended application for the non-pneumatic tire. Increasing the reference compression stiffness k_{c,ref} provides a tire with a stiffer ride and relatively smaller footprint, while decreasing the reference compression stiffness k_{c,ref} provides a tire with a softer ride and relatively larger footprint. Increasing and decreasing the reference tension stiffness k_{t,ref} provides similar resultant changes. Generally speaking, however, it has been found that a reference tension stiffness k_{t,ref} in a range of 11 to

$$150 \frac{N}{mm} / °$$

and a reference compression stiffness k_{c,ref} in a range of 11 to

$$100 \frac{N}{mm} / °$$

provides desirable non-pneumatic tire performance characteristics. More preferably, a tire is provided with a reference tension stiffness k_{t,ref} in a range of 17 to

$$140 \frac{N}{mm} / °$$

and a reference compression stiffness k_{c,ref} in a range of 11 to

$$70 \frac{N}{mm} / ° .$$

Even more preferably, a tire is provided with a reference tension stiffness k_{t,ref} in a range of 17 to

$$70 \frac{N}{mm} / °$$

and a reference compression stiffness k_{c,ref} in a range of 11 to

$$35 \frac{N}{mm} / ° .$$

Most preferably, a tire is provided with a reference tension stiffness k_{t,ref} in a range of 17 to

$$35 \frac{N}{mm} / °$$

and a reference compression stiffness k_{c,ref} in a range of 17 to

$$35 \frac{N}{mm} / ° .$$

Regardless of the specific values for reference tension stiffness k_{t,ref} and reference compression stiffness k_{c,ref}, it has also been found that providing a reference tension stiffness k_{t,ref} to reference compression stiffness k_{c,ref} ratio in the range of 0.3:1 to 8:1 results in desirable non-pneumatic tire performance characteristics. More preferably, a tire is provided with a reference tension stiffness k_{t,ref} to reference compression stiffness k_{c,ref} ratio in the range of 0.5:1 to 8:1. Most preferably, a tire is provided with a reference tension stiffness k_{t,ref} to reference compression stiffness k_{c,ref} ratio in the range of 0.5:1 to 1:1. In instances where k_{t,ref} is less than 1, the spokes of the tire may carry a majority of the load in compression. The tire structure, however, is such that force is transmitted around a circumference of the tire so that all of the spokes play a significant role in carrying a load, as is the case in top loading tires.

With the foregoing guidelines being established, the exact values for the reference tension stiffness k_{t,ref} and the reference compression stiffness k_{c,ref} are selected based on the modeling of the model tire and desired performance characteristics. The reference tension stiffness k_{t,ref} and the reference compression stiffness k_{c,ref} can then be entered into the equations to calculate the ideal tension stiffness k_{t,degree} and ideal compression stiffness k_{c,degree} values for a desired tire design having a first design width and a first design load capacity. The width of the tire being designed (i.e., first design width) is designated by w, measured in millimeters, and assumes that the spoke, the lower ring, and the upper ring are all the same width. The design load capacity of the tire being designed (i.e., first design load capacity) is designated by f and is measured in Newtons.

In one non-limiting example, a model width w_{ref} of 300 mm and a model load capacity f_{ref} of 22,200 N are used again in adjusting reference tension stiffness k_{t,ref} and the reference compression stiffness k_{c,ref} values for the modeled tire to arrive at the ideal tension stiffness k_{t,degree} and the ideal compression stiffness k_{c,degree} values for the tire being designed. Consequently, the equations becoming the following:

$${k}_{t , degree} = {k}_{t , ref} ( \frac{f}{w} ) ( 0.0135 )$$

$${k}_{c , degree} = {k}_{c , ref} ( \frac{f}{w} ) ( 0.0135 )$$

In this example, once the initial modeling is performed using a tire with a model width w_{ref} of 300 mm and a model load capacity f_{ref} of 22,200 N, ideal tension stiffness k_{t,degree} and ideal compression stiffness k_{c,degree} values can quickly be adjusted for different tire widths and different tire design load capacities. Accordingly, once the ideal tension stiffness k_{t,degree} and the ideal compression stiffness k_{c,degree} values are calculated for the tire having a first design width and a first design load capacity, the equations can again be used to calculate the ideal tension stiffness k_{t,degree} and the ideal compression stiffness k_{c,degree} values for a tire having a second design width and a second design load capacity. First, second, and subsequent tire designs can thus be quickly designed.

After the ideal tension stiffness k_{t,degree} and the ideal compression stiffness k_{c,degree} are calculated, the specific tension stiffness k_{t,specific} and the specific compression stiffness k_{c,specific} of each spoke can be determined by using the following equations:

$${k}_{t , specific} = {k}_{t , degree} ( \frac{360 °}{n} )$$

$${k}_{c , specific} = {k}_{c , degree} ( \frac{360 °}{n} )$$

According to these equations, the specific tension stiffness k_{t,specific} and the specific compression stiffness k_{c,specific} of each spoke can be determined by multiplying each of the ideal tension stiffness k_{t,degree} and the ideal compression stiffness k_{c,degree} by (360°/n), where n is the total number of spokes in the tire being designed. Performing this operation will provide the specific tension stiffness k_{t,specific} and the specific compression stiffness k_{c,specific} values of each spoke, expressed in N/mm. Accordingly, specific tension stiffness k_{t,specific} and specific compression stiffness k_{c,specific} can quickly be adjusted for tires with different number of spokes.

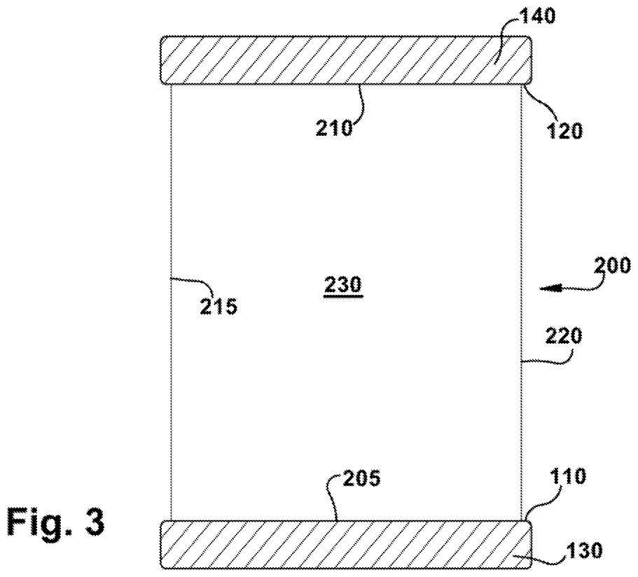

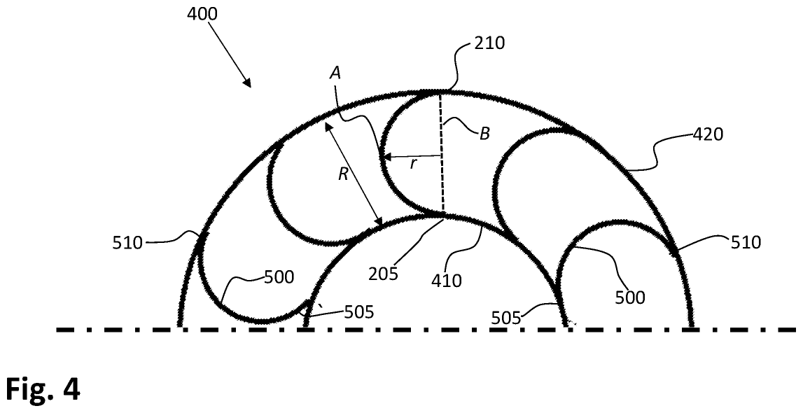

Various spoke designs may provide the desired specific tension stiffness k_{t,specific} and specific compression stiffness k_{c,specific} calculated according to the equations above, and may be achieved through a combination of geometry, material selection, and reinforcements, for example. FIG. 4 shows part of a non-pneumatic tire 400 in an unloaded condition and having an exemplary spoke design that can provide the desired specific tension stiffness k_{t,specific} and specific compression stiffness k_{c,specific}. The non-pneumatic tire 400 of FIG. 4 is substantially similar to the non-pneumatic tire 100 of FIGS. 1-3. Thus, the description of the tire of FIG. 4 will be abbreviated, and like features will be identified by like numerals increased by a factor of “300.”

The non-pneumatic tire 400 includes a lower ring 410 having a first diameter and an upper ring 420 having a second diameter greater than the first diameter. A distance between the lower ring 410 and the upper ring 420 is denoted by R. The upper ring 420 is substantially coaxial with the lower ring 410. A plurality of spokes 500 extend between and interconnect the lower ring 410 and the upper ring 420. The design of each one of the plurality of spokes 500 is substantially identical. Accordingly, further description of the plurality of spokes 500 will be made with reference to a single spoke.

Each one of the spokes 500 is substantially C-shaped and extends between a first end 505 and a second end 510 along a generally radial direction of the non-pneumatic tire 400. The first end 505 is attached to the lower ring 410. The second end 510 is attached to the upper ring 420. A straight line drawn between the attachment point of the first end 505 and the lower ring 410 may be referred to as a base and is denoted by B. An apex A of the C-shaped spoke is offset from the base B along a circumferential direction of the tire by a distance r.

It has been found that a spoke 500 having the desired specific tension stiffness k_{t,specific} and compression stiffness k_{c,specific} calculated using the aforementioned equations can be designed using the following equation:

$$r = ( 0.5 ) R$$

In this equation, the distance R between the lower ring 410 and the upper ring 420 can be calculated for a non-pneumatic tire 400 having a known inner and outer diameters. According to one example embodiment, it has been found that multiplying the distance R by (0.5) to calculate the offset distance r provides desirable non-pneumatic tire performance characteristics. In other example embodiments, it has been found that multiplying the distance R by values ranging from 0.5 to 2 provides acceptable non-pneumatic tire characteristics. In addition to providing a spoke having the desired specific tension stiffness k_{t,specific} and specific compression stiffness k_{c,specific}, it has been found that the above equation also provides a spoke having approximately linear tension and compression behavior.

According to one example embodiment, the C-shaped spoke 500 is manufactured from steel with an elastic modulus of approximately 200 gigapascals, a thickness in the circumferential direction of 1.575 mm, and a width in the axial direction of 305 mm. These parameters may be varied without departing from the design objectives discussed above in regard to specific tension stiffness k_{t,specific} and compression stiffness k_{c,specific}. For example, the spoke may be manufactured from carbon fiber reinforced polymers, glass reinforced polymers, plastics (thermoplastics or thermosets), and other metals such as stainless steel. As another example, the spokes may have a thickness of 1-25 mm and, more preferably, 1-10 mm. As yet another example, the spokes may have a width of 200-305 mm and, more preferably, 260-305 mm. It is appreciated that changing one design parameter may require changing another design parameter in order to maintain the desired design objectives in regard to specific tension stiffness k_{t,specific} and compression stiffness k_{c,specific}. For example, if the spoke is made from polymer rather than steel, it may be necessary to increase the thickness of the spoke to 23 mm, assuming the width of the spoke remains at 305 mm. As another example, if the width of the spoke is reduced, it may be necessary to increase the thickness of the spoke.

The foregoing spoke design is only one possibility for a design that provides the specific tension stiffness k_{t,specific} and compression stiffness k_{c,specific} disclosed herein. Other spoke designs meeting the specific tension stiffness k_{t,specific} and compression stiffness k_{c,specific} design objectives are possible.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. A non-pneumatic tire comprising:
a lower ring having a first diameter;
an upper ring having a second diameter greater than the first diameter, the upper ring being substantially coaxial with the lower ring; and
a plurality of spokes extending between and interconnecting the lower ring and the upper ring;
wherein the plurality of spokes have a tension stiffness of greater than or equal to 11 and less than or equal to
$$150 \frac{N}{mm} / ° ,$$
and a compression stiffness of greater than or equal to 11 and less than or equal to
$$100 \frac{N}{mm} / ° .$$

17. The non-pneumatic tire of claim 16, wherein each one of the plurality of spokes is substantially C-shaped.

18. The non-pneumatic tire of claim 17, wherein for each one of the plurality of spokes, an apex of the spoke is offset in a circumferential direction of the tire from a base of the spoke by a distance in the range of 0.5 to 2 times the difference between the second diameter and the first diameter.

19. The non-pneumatic tire of claim 16, wherein each one of the plurality of spokes has at least one of linear tension behavior and linear compression behavior.

20. The non-pneumatic tire of claim 16, wherein each one of the plurality of spokes has linear tension behavior and linear compression behavior.

21. The non-pneumatic tire of claim 16, wherein each one of the plurality of spokes has a thickness in a circumferential direction of the tire of between 1-25 mm.

22. The non-pneumatic tire of claim 16, wherein each one of the plurality of spokes has a width in an axial direction of the tire of the tire of between 260-305 mm.

23. A non-pneumatic tire comprising:
a lower ring having a first diameter;
an upper ring having a second diameter greater than the first diameter, the upper ring being substantially coaxial with the lower ring; and
a plurality of spokes extending between and interconnecting the lower ring and the upper ring;
wherein the plurality of spokes have a tension stiffness to compression stiffness ratio in the range of 0.3:1 to 8:1.

24. The non-pneumatic tire of claim 23, wherein each one of the plurality of spokes is substantially C-shaped.

25. The non-pneumatic tire of claim 24, wherein for each one of the plurality of spokes, an apex of the spoke is offset in a circumferential direction of the tire from a base of the spoke by a distance in the range of 0.5 to 2 times the difference between the second diameter and the first diameter.

26. The non-pneumatic tire of claim 23, wherein each one of the plurality of spokes has at least one of linear tension behavior and linear compression behavior.

27. The non-pneumatic tire of claim 23, wherein each one of the plurality of spokes has linear tension behavior and linear compression behavior.

28. The non-pneumatic tire of claim 23, wherein each one of the plurality of spokes has a thickness in a circumferential direction of the tire of between 1-25 mm.

29. The non-pneumatic tire of claim 23, wherein each one of the plurality of spokes has a width in an axial direction of the tire of the tire of between 260-305 mm.

30. A method of manufacturing a non-pneumatic tire comprising the steps of:
modeling a model tire having a model width and a model design load capacity;
selecting a reference tension stiffness value and a reference compression stiffness value based on the step of modeling, the reference tension stiffness value being greater than or equal to 11 and less than or equal to
$$150 \frac{N}{mm} / ° ,$$
the reference compression stiffness being greater than or equal to 11 and less than or equal to
$$100 \frac{N}{mm} / ° ;$$
calculating a first ideal tension stiffness and a first ideal compression stiffness for a tire design having a first design width and a first design capacity by adjusting the reference tension stiffness value and the reference compression stiffness value selected during the step of selecting; and
and producing a first non-pneumatic tire having the first design width and the first design capacity, and further having the first ideal tension stiffness and the first ideal compression stiffness calculated during the step of calculating.

31. The method of manufacturing a tire of claim 30, wherein the model width is 300 mm and the model design load capacity is 22,200 N.

32. The method of manufacturing a non-pneumatic tire of claim 31, wherein the step of calculating the first ideal tension stiffness is calculated according to the equation:
$${k}_{t , degree} = {k}_{t , ref} ( \frac{{w}_{ref}}{w} ) ( \frac{f}{{f}_{ref}} )$$
wherein k_{t,degree} is the ideal tension stiffness, k_{t,ref} is the reference tension stiffness value selected during the step of selecting, ƒ is the first design load capacity, and w is the first design width, and
the step of calculating the first ideal compression stiffness is calculated according to the equation:
$${k}_{c , degree} = {k}_{c , ref} ( \frac{{w}_{ref}}{w} ) ( \frac{f}{{f}_{ref}} )$$
wherein k_{c,degree} is the ideal compression stiffness, k_{c,ref} is the reference compression stiffness value selected during the step of selecting, ƒ is the first design load capacity, and w is the first design width

33. The method of manufacturing a non-pneumatic tire of claim 30, wherein the reference tension stiffness value to reference compression stiffness value is a ratio in the range of 0.3:1 to 8:1.

34. The method of manufacturing a non-pneumatic tire of claim 30, wherein the step of producing includes providing a lower ring and an upper ring, forming a plurality of C-shaped spokes, and interconnecting the lower ring and the upper ring with the plurality of C-shaped spokes.

35. The method of manufacturing a non-pneumatic tire of claim 34, wherein the step of forming a plurality of C-shaped spokes includes offsetting an apex of each spoke from a base of each spoke in a circumferential direction of the non-pneumatic tire by a distance in the range of 0.5 to 2 times the difference between a diameter of the upper ring and a diameter of the lower ring.
